(19) United States
(12) Patent Application Publication
(10) Pub. No.: US 2025/0370552 A1
(43) Pub. Date: Dec. 4, 2025

(54) Input Device and Input Method

(71) Applicant: Yamaha Corporation, Hamamatsu-shi (JP)

(72) Inventor: Yoshifumi OIZUMI, Hamamatsu-shi (JP)

(21) Appl. No.: 19/225,093

(22) Filed: Jun. 2, 2025

(30) Foreign Application Priority Data
Jun. 3, 2024 (JP) 2024-089916

(51) Int. Cl. G06F 3/023; H01H 9/16

(52) U.S. Cl. CPC G06F 3/023; H01H 9/16

(57) ABSTRACT

An input device includes an operator, an output unit, and a display device. The output unit is configured to receive a first operation and a second operation. The output unit is configured to output a first command corresponding to the first operation and a second command corresponding to the second operation. The display device is configured to perform a first display corresponding to a first state in which the first command is output and a second display corresponding to a second state in which the second command is output. The display device is disposed in a periphery of the operator. The display device is divided into a first display region and a second display region. The first display includes a state in which the first display region is displayed, and the second display includes a state in which the second display region is displayed.

### CROSS-REFERENCE TO RELATED APPLICATIONS

This application is based on and claims priority under 35 USC 119 from Japanese Patent Application No. 2024-089916 filed on Jun. 3, 2024, the contents of which are incorporated herein by reference.

### BACKGROUND

An embodiment of the present disclosure relates to an input device and an input method.

JP2000-133085A discloses a switching operation device that performs a switching operation of function modes by rotating a dial switch rotatably installed on a display panel. The switching operation device includes a plurality of light-emitting elements for indicator color display, which back-lights each picture display with an indication color corresponding to an operation instruction by the dial switch.

### SUMMARY

The device of JP2000-133085A allows a uniform operation action by a rotation operation using one operator, and thus cannot easily output a plurality of control commands by the rotation operation.

An object of the present embodiment is to provide an input device capable of easily outputting a plurality of control commands using one operator and indicating a state change caused by the output control commands in an easily-recognizable manner.

In an aspect of the present embodiment, there is provided an input device including: an operator configured to receive a first operation, the operator being further configured to receive a second operation, an operation action of the second operation to the operator being different from that of the first operation; an output unit configured to output, to another device, a first command corresponding to the first operation and a second command corresponding to the second operation; and a display device configured to perform a first display corresponding to a first state in which the first command is output and a second display corresponding to a second state in which the second command is output, in which: the display device is disposed in a periphery of the operator, the display device is divided into a first display region and a second display region, and the first display includes a state in which the first display region is displayed, and the second display includes a state in which the second display region is displayed.

According to one embodiment of the present disclosure, it is possible to easily output a plurality of control commands using one operator and to easily confirm a state change caused by the output control commands.

### BRIEF DESCRIPTION OF DRAWINGS

The present disclosure will be described in detail based on the following without being limited thereto, wherein:

FIG. 1 is a block diagram illustrating a configuration of an audio conference system 1;

FIG. 2 is a schematic perspective view of a room 3;

FIG. 3 is an external plan view of an input device 10;

FIG. 4 is a block diagram illustrating a configuration of the input device 10;

FIG. 5 is a block diagram illustrating a configuration of a signal processing device 20;

FIG. 6 is a flowchart illustrating an operation of the input device 10;

FIG. 7 is an external plan view of the input device 10 according to Modification 1;

FIG. 8 is a block diagram illustrating a configuration of the input device 10 according to Modification 1; and

FIGS. 9A to 9E are external plan views illustrating state transitions of the input device 10.

### DETAILED DESCRIPTION

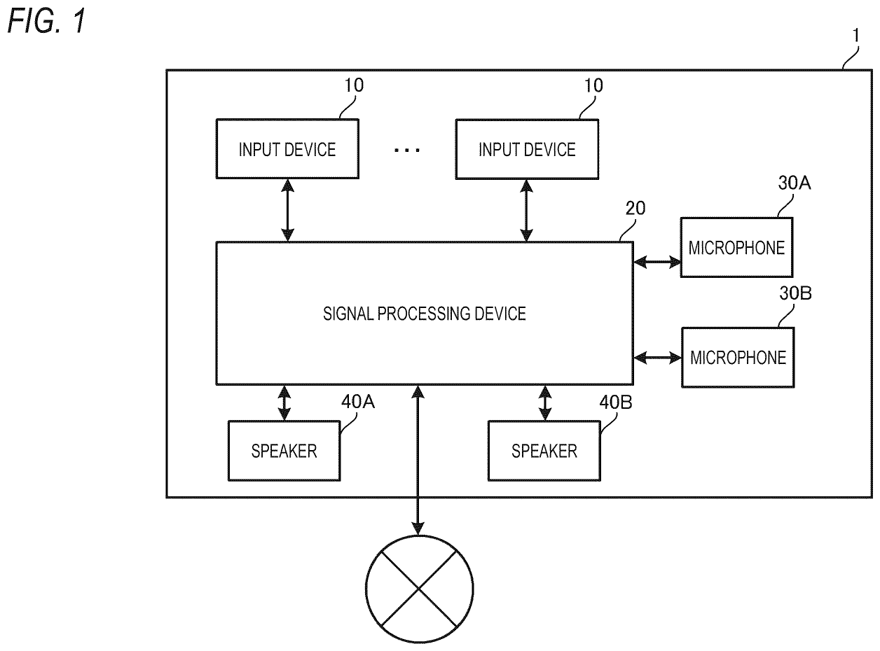

FIG. 1 is a block diagram illustrating a configuration of an audio conference system 1 according to the present embodiment. The audio conference system 1 includes a plurality of input devices 10, a signal processing device 20, a microphone 30A, a microphone 30B, a speaker 40A, and a speaker 40B. The signal processing device 20 is connected to the plurality of input devices 10, the microphone 30A, the microphone 30B, the speaker 40A, and the speaker 40B. The signal processing device 20 is connected to a remote PC or the like via a network. Alternatively, the signal processing device 20 is connected to a PC via a USB or the like, and is connected to the remote PC via the PC. The plurality of input devices 10, the microphone 30A, the microphone 30B, the speaker 40A, and the speaker 40B may be connected to the signal processing device 20 via a network.

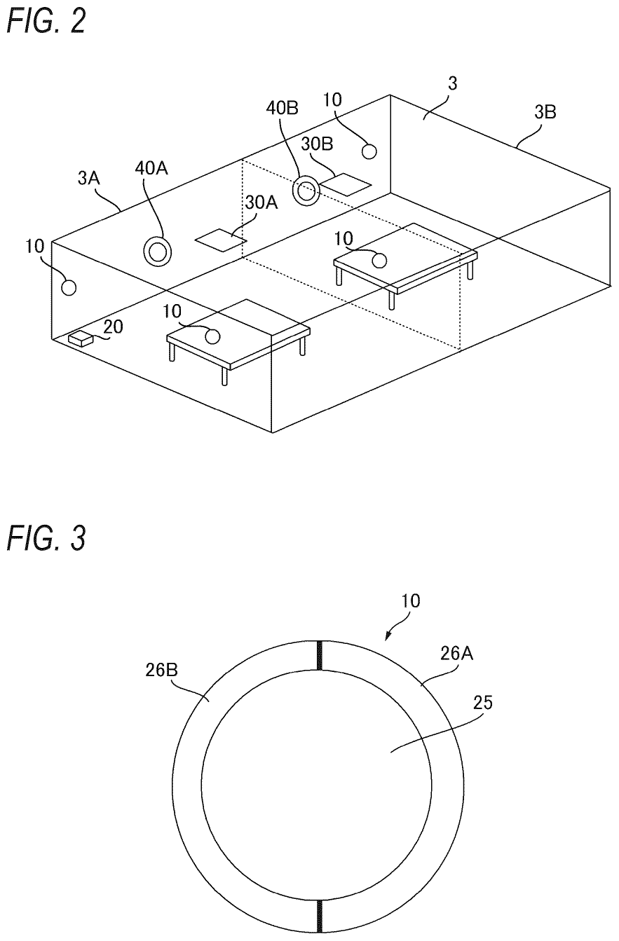

FIG. 2 is a schematic perspective view of a room 3. The room 3 is a conference room that can be divided into a first room 3A and a second room 3B by a movable partition. The microphone 30A and the microphone 30B are installed on a ceiling of a room as an example. The microphone 30A is installed at a position corresponding to the first room 3A, and the microphone 30B is installed at a position corresponding to the second room 3B.

The speaker 40A and the speaker 40B are installed on wall surfaces in the rooms as an example. The speaker 40A is installed at a position corresponding to the first room 3A, and the speaker 40B is installed at a position corresponding to the second room 3B.

As an example, the input devices 10 are installed on desks installed in the rooms and wall surfaces in the rooms. In the example of FIG. 2, four input devices 10 are installed in the room 3.

The signal processing device 20 is installed on a floor at a position corresponding to the first room 3A as an example. The installation position of the signal processing device 20 is not limited to the example of FIG. 2.

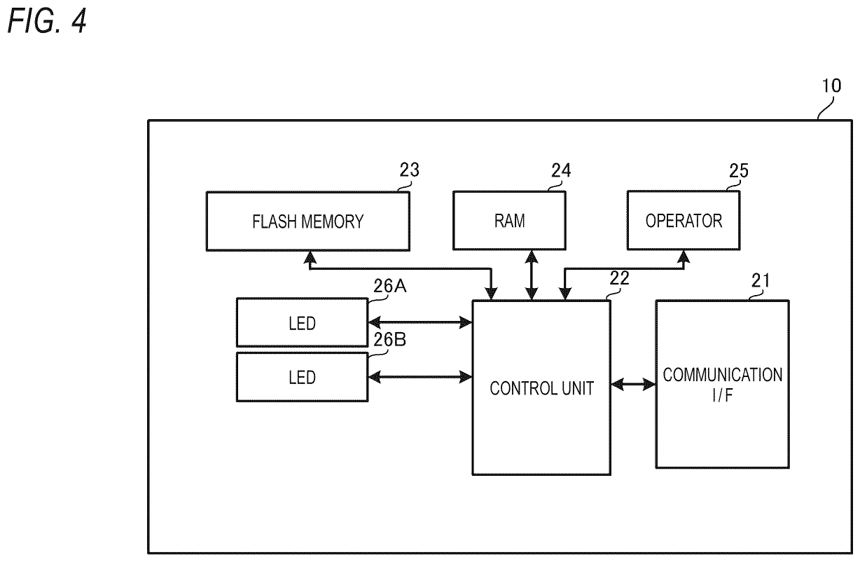

FIG. 3 is an external plan view of the input device 10, and FIG. 4 is a block diagram illustrating a configuration of the input device 10. The input device 10 has a thin cylindrical shape in appearance, and has a circular shape in a plan view. The input device 10 includes a communication I/F 21, a control unit 22, a flash memory 23, a RAM 24, an operator 25, an LED 26A, and an LED 26B.

The operator 25 is, for example, a circular push button in a plan view. The operator 25 is disposed at a center of the input device 10 in a plan view.

The LED 26A and the LED 26B are examples of a display device. The LED 26A and the LED 26B are disposed in a vicinity of a periphery of the operator 25 in a plan view of the input device 10. The LED 26A and the LED 26B are arranged so as to divide the periphery of the operator 25 into two parts in a plan view. That is, the display device is divided into the LED 26A as a first display region and the LED 26B as a second display region.

The control unit 22 collectively controls an operation of the input device 10 by reading an operation program from the flash memory 23 to the RAM 24. The program does not need to be stored in the flash memory 23 of the input device 10. The control unit 22 may download data from a server or the like each time and read the data into the RAM 24. The control unit 22 receives an operation of a user via the operator 25. The control unit 22 may include a processor.

The operator 25 receives, for example, a short-time push operation as a first operation. In addition, the operator 25 receives, for example, a long-time push operation as a second operation whose operation action is different from the first operation. The short time is, for example, a continuous push operation within one second, and the long time is, for example, a continuous push operation exceeding one second.

The control unit 22 outputs various control commands corresponding to an operation of the operator 25 to the signal processing device 20, which is another device, via the communication I/F 21. A first command corresponding to the first operation and a second command corresponding to the second operation are output to the signal processing device 20, which is another device, via the communication I/F 21. For example, when the first operation related to the short-time push operation is received from the input device 10 installed on a desk at a position corresponding to the first room 3A, the control unit 22 outputs a control command for muting the microphone 30A to the signal processing device 20.

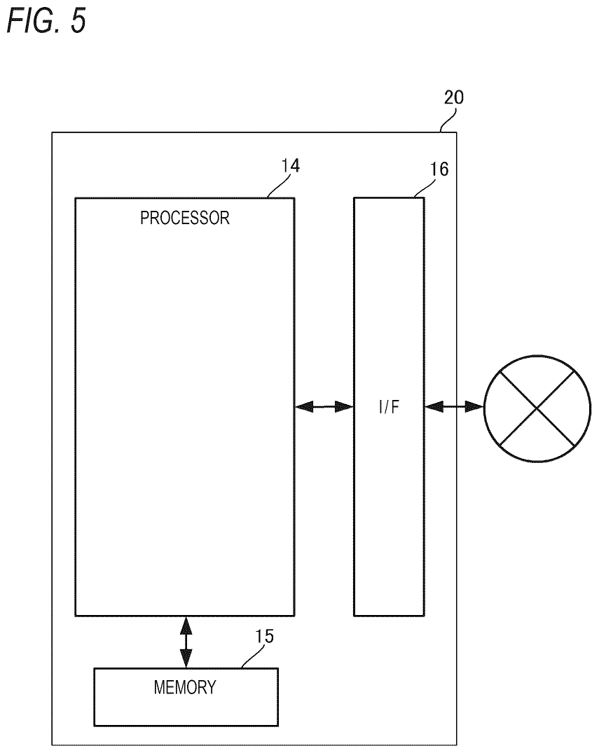

FIG. 5 is a block diagram illustrating a configuration of the signal processing device 20. The signal processing device 20 includes a processor 14, a memory 15, and an interface (I/F) 16.

The memory 15 is a storage medium that stores an operation program of the processor 14. The processor 14 reads the operation program from the memory 15 and performs various operations. The program does not need to be stored in the memory 15. For example, the program may be stored in a storage medium of an external device such as a server. In this case, the processor 14 may read and execute the program from the server each time.

The processor 14 receives sound signals acquired by the microphone 30A and the microphone 30B. Each of the microphone 30A and the microphone 30B is, for example, an array microphone including a plurality of microphones. The processor 14 performs a predetermined sound processing on the sound signals of the plurality of microphones acquired by the microphone 30A and the microphone 30B. For example, the processor 14 performs beamforming. The beamforming is processing of forming a sound collection beam having a directivity in a predetermined direction by adding delays to the sound signals acquired by the microphone 30A and the microphone 30B and synthesizing the sound signals. The sound collection beam can also form a directivity that focuses on a predetermined position. For example, when a voice of a talker is detected, the processor 14 forms a sound collection beam focused on a position of the talker. For example, the processor 14 obtains a correlation value of the sound signals of the plurality of microphones to obtain a difference (phase difference) between voice acquisition timings, and detects the position of the talker. The processor 14 can uniquely obtain the position of the talker by obtaining the difference between the voice acquisition timings of the three or more microphones. The processor 14 can acquire a voice of the talker with high sensitivity by forming a directivity that focuses on the obtained position of the talker. A plurality of sound collection beams may be formed at the same time. As long as there are at least two or more microphones, a sound collection beam can be formed.

The processor 14 outputs a sound signal related to the sound collection beam to the I/F 16. The I/F 16 is a communication I/F such as LAN, USB, HDMI (registered trademark), or Bluetooth (registered trademark). The I/F 16 is connected to a network, for example, via the LAN. The signal processing device 20 transmits the sound signal related to the sound collection beam to the remote PC or the like via a network.

The signal processing device 20 receives a sound signal from the remote PC via the network. The processor 14 outputs the sound signal received via the network to the speaker 40A and the speaker 40B. The speaker 40A and the speaker 40B receive a sound signal and output sound.

Accordingly, the user of the signal processing device 20 can perform an audio conference with a user in a remote location.

The room 3 of the present embodiment is a conference room that can be divided into the first room 3A and the second room 3B by the movable partition. That is, the room 3 of the present embodiment has a first state in which the entire room 3 is used and a second state in which the room 3 is divided into the first room 3A and the second room 3B for use.

In the first state in which the entire room 3 is used, the microphone 30A and the microphone 30B collect sound of the entire space of the room 3. In the first state, the speaker 40A and the speaker 40B output the sound to the entire space of the room 3. In the first state, the signal processing device 20 mixes the sound signals collected by the microphone 30A and the microphone 30B and transmits the mixed sound signals to the same remote location. Further, in the first state, the signal processing device 20 distributes and outputs sound signals received from the remote location to the speaker 40A and the speaker 40B.

In the second state in which the room 3 is divided into the first room 3A and the second room 3B are divided for use, the microphone 30A collects sound of the first room 3A, and the microphone 30B collects sound of the second room 3B. In the second state, the speaker 40A outputs the sound to the first room 3A, and the speaker 40B outputs the sound to the second room 3B. In the second state, the signal processing device 20 transmits the sound signals collected by the microphone 30A and the microphone 30B to corresponding different remote locations (first remote location and second remote location), respectively. In the second state, the signal processing device 20 outputs a sound signal received from the first remote location to the speaker 40A, and outputs a sound signal received from the second remote location to the speaker 40B.

Therefore, the user needs to change settings related to a sound processing of the signal processing device 20 between the first state and the second state. That is, the user needs to set first setting data related to a first sound processing in the first state and set second setting data related to a second sound processing in the second state with respect to the signal processing device 20.

The user of the present embodiment can easily output a plurality of control commands using one operator, and easily confirm a state change caused by the output control commands. More specifically, the user can output the first command for calling the first setting data by performing the short-time push operation on the operator 25, and can output the second command for calling the second setting data by performing the long-time push operation on the operator 25. In addition, the user of the present embodiment can easily confirm the state change caused by the output commands based on lighting states of the LED 26A and the LED 26B.

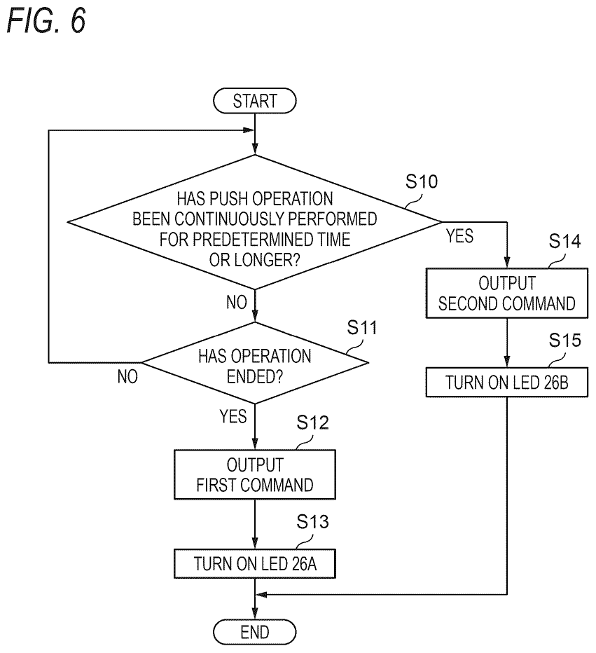

FIG. 6 is a flowchart illustrating the operation of the input device 10. The input device 10 starts the operation illustrated in FIG. 6 when detecting the push operation on the operator 25. First, the input device 10 determines whether the push operation has been continuously performed on the operator 25 for a predetermined time or longer (S10). When determining that a duration of the push operation has not exceeded the predetermined time (NO in S10), the input device 10 further determines whether the push operation has ended (S11). When determining that the push operation has not ended (NO in S11), the input device 10 returns to the determination in S10.

When determining that the push operation has ended (YES in S11), the input device 10 outputs the first command to the signal processing device 20 (S12). The input device 10 turns on only the LED 26A as a first display corresponding to the first state in which the first command is output (S13). The user can easily confirm the first state in which the first command is output by confirming the state in which only the LED 26A is turned on.

When the first command is received, the signal processing device 20 calls the first setting data related to the first sound processing. Based on the first setting data, the signal processing device 20 mixes the sound signals collected by the microphone 30A and the microphone 30B and transmits the mixed sound signals to the same remote location. In addition, based on the first setting data, the signal processing device 20 distributes and outputs the sound signal received from the remote location to the speaker 40A and the speaker 40B.

When determining that the duration of the push operation has exceeded the predetermined time (YES in S10), the input device 10 outputs the second command to the signal processing device 20 (S14). When S10 is YES, the input device 10 may further determine whether the push operation has ended. The input device 10 may return to the determination in S10 when determining that the push operation has not ended, and may output the second command to the signal processing device 20 when determining that the push operation has ended. The input device 10 turns on only the LED 26B as a second display corresponding to the second state in which the second command is output (S15). The user can easily confirm the second state in which the second command is output by confirming the state in which only the LED 26B is turned on.

When the second command is received, the signal processing device 20 calls the second setting data related to the second sound processing. Based on the second setting data, the signal processing device 20 transmits the sound signals collected by the microphone 30A and the microphone 30B to corresponding different remote locations (first remote location and second remote location), respectively. Further, based on the second setting data, the signal processing device 20 outputs the sound signal received from the first remote location to the speaker 40A, and outputs the sound signal received from the second remote location to the speaker 40B.

As described above, the user of the input device 10 of the present embodiment can selectively and easily output the first command or the second command using the operator 25, which is one push button. In addition, the user can easily confirm the state change caused by the output commands by confirming the lighting states of the LED 26A and the LED 26B.

Lighting modes of the LED 26A and the LED 26B are not limited to the above-described example. For example, both the LED 26A and the LED 26B may be turned on in the first state, and only one of the LED 26A and the LED 26B may be turned on in the second state. Alternatively, for example, both the LED 26A and the LED 26B may be turned on in blue in the first state, and only one of the LED 26A and the LED 26B may be turned on in blue and the other may be turned on in red in the second state.

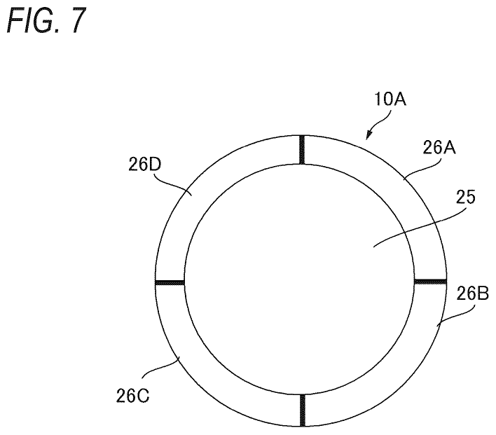

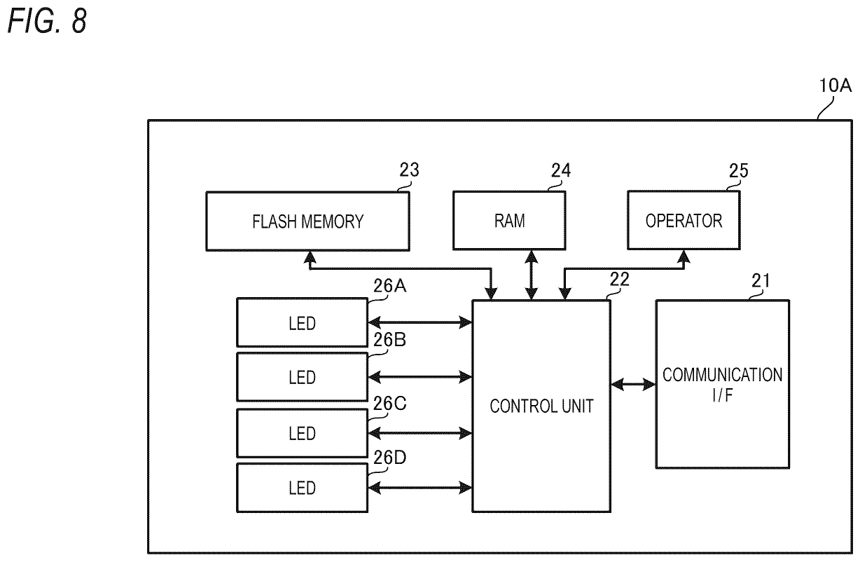

FIG. 7 is an external plan view of an input device 10A according to Modification 1, and FIG. 8 is a block diagram illustrating a configuration of the input device 10A according to Modification 1. The same components as those of the input device 10 in FIGS. 3 and 4 are denoted by the same reference numerals, and description thereof will be omitted. The input device 10A includes four LEDs, that is, an LED 26A, an LED 26B, an LED 26C, and an LED 26D.

A display device of Modification 1 is divided into a first display region (LED 26A), a second display region (LED 26B), a third display region (LED 26C), and a fourth display region (LED 26D). The display device of Modification 1 performs a first display in which only the LED 26A is turned on, a second display in which only the LED 26B is turned on, a third display in which only the LED 26C is turned on, and a fourth display in which only the LED 26D is turned on. The input device 10A has four states: a first state in which a first command is output, a second state in which a second command is output, a third state in which a third command is output, and a fourth state in which a fourth command is output.

For example, the user can output the first command for calling the first setting data by performing the short-time push operation on the operator 25, and can output the second command for calling the second setting data by performing the long-time push operation on the operator 25. The third command for calling third setting data can be output by performing a long-time (for example, 2 seconds or more) push operation. The fourth command for calling fourth setting data can be output by performing a long-time (for example, 3 seconds or more) push operation. In addition, the user of the present embodiment can easily confirm a state change caused by the output commands based on lighting states of the LED 26A, the LED 26B, the LED 26C, and the LED 26D.

When the first command is received, the signal processing device 20 calls the first setting data related to the first sound processing. When the second command is received, the signal processing device 20 calls the second setting data related to the second sound processing. When the third command is received, the signal processing device 20 calls the third setting data related to a third sound processing. When the fourth command is received, the signal processing device 20 calls the fourth setting data related to a fourth sound processing.

Accordingly, the input device 10A of Modification 1 can easily output a larger number of control commands using one operator 25 for a wider variety of indoor layouts, and can easily confirm the state change caused by the output control commands.

The input device 10 according to Modification 2 transitions to a selection state in which a selection operation of the first command and the second command is received when the operator 25 is pushed for a predetermined time or longer. In the selection state, the input device 10 receives a change in the selection of the first command and the second command when receiving a short-time push operation. That is, in the selection state, the input device 10 switches between the selection state of the first command and the selection state of the second command every time the short-time push operation is received. When the long-time push operation is received, the input device 10 outputs either the first command or the second command selected at that time.

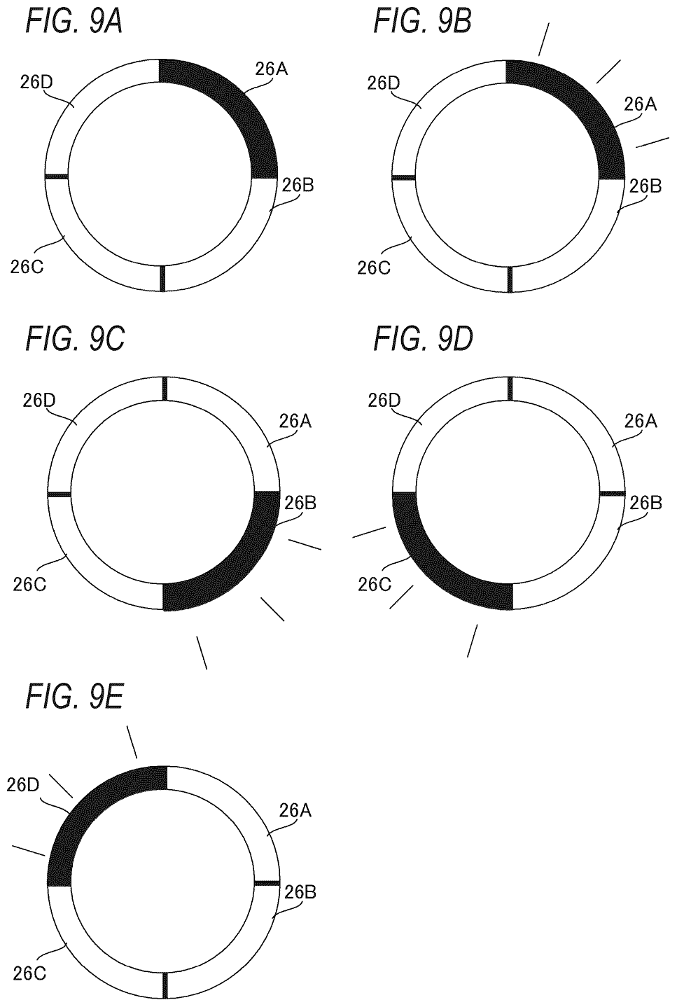

The same applies to a case of the input device 10A that further outputs the plurality of (for example, four) commands as illustrated in Modification 1. FIGS. 9A to 9E are external plan views illustrating state transitions of the input device 10A. For example, in the first state in which the first command is output, the input device 10A turns on the LED 26A as illustrated in FIG. 9A. The input device 10A transitions to a selection state in which a selection operation of the first command, the second command, the third command, and the fourth command is received when a push operation for a predetermined time or longer on the operator 25 is received. For example, in a case in which the first command is in the selection state, the input device 10A causes the LED 26A to blink as illustrated in FIG. 9B.

In the selection state, the input device 10A receives a change in the selection of the first command, the second command, the third command, and the fourth command when a short-time push operation is received. That is, in the selection state, the input device 10A switches between the selection state of the first command, the selection state of the second command, the selection state of the third command, and the selection state of the fourth command each time the short-time push operation is received. For example, when a short-time push operation is received in a case in which the first command is in the selection state, the input device 10A transitions to the selection state of the second command and causes the LED 26B to blink as illustrated in FIG. 9C. For example, when a short-time push operation is received in a case in which the second command is in the selection state, the input device 10A transitions to the selection state of the third command and causes the LED 26C to blink as illustrated in FIG. 9D. For example, when a short-time push operation is received in a case in which the third command is in the selection state, the input device 10A transitions to the selection state of the fourth command and causes the LED 26D to blink as illustrated in FIG. 9E. For example, when a short-time push operation is received in a case in which the fourth command is in the selection state, the input device 10A transitions to the selection state of the first command and causes the LED 26A to blink as illustrated in FIG. 9B.

When a long-time push operation is received, the input device 10A outputs one of the first command, the second command, the third command, and the fourth command selected at that time. For example, when a long-time push operation is received in the case in which the first command is in the selection state, the input device 10A outputs the first command and turns on the LED 26A as illustrated in FIG. 9A.

Accordingly, the input device 10A according to Modification 2 can perform a more complicated input operation even in two operation actions of the short-time push operation and the long-time push operation.

In the above-described embodiments, an example is shown in which the first command includes a call command of the first setting data related to the first sound processing, and the second command includes a call command of the second setting data related to a second sound processing. However, the command to be output by the input device is not limited to the setting data related to the sound processing. For example, when the signal processing device 20 performs a video processing on a video signal, the first command may include a call command of first setting data related to a first video processing, and the second command may include a call command of second setting data related to a second video processing.

In the above-described embodiments, the push button is shown as the operator. However, the operator is not limited to the push button. For example, the operator may be a touch panel and receive a touch operation of the user. In the above-described embodiments, either the first operation or the second operation is received based on a difference in a length of a time for which the push button is pushed. However, for example, either the first operation or the second operation may be received based on a difference in the number of times of the push operations within a predetermined time. For example, one push operation within one second may be set as the first operation, and two push operations within one second may be set as the second operation.

In the above-described embodiments, the display region is divided into two or four regions and displayed for one operator, and the present disclosure is not limited thereto. In the input device, a plurality of functions may be assigned to one operator. In this case, the display region may be divided into (1 to N) and displayed for the plurality of functions (1 to N).

The description of the present embodiment should be considered to be illustrative in all respects and not restrictive. The scope of the present invention is indicated by the claims rather than the above-described embodiment. Further, the scope of the present invention includes the scope equivalent to the claims.

1. An input device comprising:
an operator configured to receive a first operation, the operator being further configured to receive a second operation, an operation action of the second operation to the operator being different from that of the first operation;
an output unit configured to output, to another device, a first command corresponding to the first operation and a second command corresponding to the second operation; and
a display device configured to perform a first display corresponding to a first state in which the first command is output and a second display corresponding to a second state in which the second command is output, wherein
the display device is disposed in a periphery of the operator,
the display device is divided into a first display region and a second display region, and
the first display includes a state in which the first display region is displayed, and the second display includes a state in which the second display region is displayed.

2. The input device according to claim 1, wherein
the first command includes a call command of first setting data related to a first sound processing, and
the second command includes a call command of second setting data related to a second sound processing.

3. The input device according to claim 1, wherein
the operator comprises a push button.

4. The input device according to claim 3, wherein
the operator is configured to distinguish between the first operation or the second operation based on a difference in a length of time for which the push button is pushed.

5. The input device according to claim 4, wherein
the output unit is configured to:
transition, in response to the push button being pushed for a predetermined time or longer, to a selection state in which a selection operation of the first command and the second command is received, and
receive a change in selection of the first command and the second command in response to a push operation for less than the predetermined time being received in the selection state, and output the first command or the second command being selected when the push button is pushed for the predetermined time or longer.

6. An input method comprising:
receiving an operation to an operator configured to receive a first operation and receiving a second operation, an operation action of the second operation to the operator being different from that of the first operation;
outputting a first command corresponding to the first operation and a second command corresponding to the second operation to another device; and
causing a display device to perform a first display corresponding to a first state in which the first command is output and a second display corresponding to a second state in which the second command is output, wherein
the display device is disposed in a periphery of the operator,
the display device is divided into a first display region and a second display region, and
the first display includes a state in which the first display region is displayed, and the second display includes a state in which the second display region is displayed.
